(19) United States
(12) Patent Application Publication
(10) Pub. No.: US 2002/0165764 A1
(43) Pub. Date: Nov. 7, 2002

(54) ELECTRONIC MERCHANDIZING SYSTEM ENCLOSURES

(75) Inventors: THOMAS WADE, APTOS, CA (US); GEOFF FLEISSNER, BEN LOMAND, CA (US); DATHAN GUILEY, SANTA CRUZ, CA (US); G. WILLIS ASHER, WATSONVILLE, CA (US); KEITH KELSEN, SCOTTS VALLEY, CA (US)

Correspondence Address: DAVID H JAFFER ESQ, PILLSBURY WINTHROP LLP, 2550 HANOVER STREET, PALO ALTO, CA, 94304-1115, US

(73) Assignee: David Jaffer

(21) Appl. No.: 09/350,681

(22) Filed: Jul. 9, 1999

(51) Int. Cl. G06F 17/60

(52) U.S. Cl. 705/14

(57) ABSTRACT

An electronic merchandizing system including a merchandising center having a large feature screen theatre located in a shopping area for display of product feature productions and advertisements of goods, orders for which can be placed via a computer network. The theatre includes an individual touch screen display terminal for each participant, allowing access to a merchandizing center web site through which orders can be placed and products viewed in addition to those being featured on the large feature screen. The center has a lobby area in which are placed additional lobby terminals for use by members in accessing the center web site. The member can also access the center web site and its features from a remote terminal at home or office over the internet. In order to access the web site, a consumer must become a member of the center and be presented with a smart card having member personal data for identification of the member as well as a listing of individual interests. The center computer system/server reads the interests of attendees in the theatre and adjusts the product features displayed accordingly. As an incentive for members to use the center and web site for purchasing, members earn coupons and game points whenever they access the site or attend the theatre or place an order. The coupons are redeemable by businesses advertising their products through the system. The game points are used to play games, included with the site. In addition to the enjoyment of playing the games, members earn play points and coupons, and can win prizes by playing. A record of the coupons and game points is stored on the member's smart card as well as the system server.

### BACKGROUND OF THE INVENTION

1. Field of the Invention

The present invention relates generally to methods and apparatus for electronic merchandizing, and more particularly to a system including a theater having a large feature screen for display of products and separate terminals for individual viewing and product ordering, and further including an internet connection to allow subscribers to access the system merchandising information through a web site and a personal terminal.

2. Brief Description of the Prior Art

Merchandise has traditionally been sold through retail stores where the customer can view and feel the product. Catalog sales have been particularly popular in the past in small rural communities where comparable goods were not in stock in local stores. As communities have grown, catalog sales have become less popular, but continue in specialty product areas, and where significantly lower prices can be offered through catalog purchasing. More recently, the internet is now being used to buy and sell products, which has the advantage of providing shopping without leaving the home. A disadvantage is that an average consumer enjoys and benefits from being able to see and touch the actual products and compare them with products of competing vendors. Because of this, large shopping centers are very popular. Some catalog sales companies combine the advantages of a large shopping center with catalog sales by maintaining catalog stores in large shopping areas, where customers can refer to catalog items and then compare the catalog items with competing merchandise in the same shopping center. Larger catalog companies often stock a variety of sample merchandise in their catalog store, or include a companion, retail outlet to draw a customer's attention.

Consumers who purchase through internet sites from a home computer do not have the benefit of ready access to comparable goods in shopping centers. It would therefore appear that both the consumer and advertiser would benefit from a system that integrates electronic merchandising with tangible shopping centers.

### SUMMARY

It is therefore an object of the present invention to provide an electronic merchandizing system including a merchandising center having a large screen retail theatre, locatable in a shopping center, through which consumers can view a video display of products and make purchases.

It is a further object of the present invention to provide a retail theatre, including a large feature screen for display of product feature productions and related material, and individual computer display terminals that allow a consumer to view particular, selected product advertisements of interest.

It is a still further object of the present invention to provide an electronic merchandising system including a retail theatre located in a shopping area, and including an internet web site connection making electronically displayable content of the system available to consumers through their personal computers via the internet.

It is another object of the present invention to provide an electronic merchandising system in which consumers can secure credits in the form of points for viewing product descriptions, and win prizes by playing games, the points redeemable toward the purchase of a variety of selected products.

Briefly, a preferred embodiment of the present invention includes an electronic merchandizing system including a merchandizing center having a theatre with a large feature screen located in a shopping area for display of product feature productions and advertisements of goods, orders for which can be placed via a computer network. The theatre includes an individual touch screen display (theater terminal) for each participant, allowing access to a merchandizing center web site through which orders can be placed and products viewed in addition to those being featured on the large screen. The center has a lobby area in which are placed additional lobby terminals for use by members in accessing the center web site. In order to access the web site, a consumer must become a member of the center and be presented with a smart card having member personal data for identification of the member as well as a listing of individual interests. The center computer system/server reads the interests of attendees in the theatre and adjusts the product features displayed accordingly. As an incentive for members to use the center and web site for purchasing, members earn coupons and game points whenever they access the site or attend the theatre or place an order. The coupons are redeemable by businesses advertising their products through the system. The game points are used to play games, included with the site. In addition to the enjoyment of playing the games, members earn play points and coupons, and can win prizes by playing. A record of the coupons and game points is stored on the member's smart card as well as the system server.

An advantage of the present invention is that it provides a consumer with the benefits of on-line purchasing in a shopping center environment.

A further advantage of the present invention is that it provides a mail order/catalog business an advertising medium that more effectively competes with shopping center retail stores.

### IN THE DRAWING

FIG. 1 is a pictorial view of the merchandizing system;

FIG. 2 shows interconnections between major system components;

FIG. 3 is a flow chart summarizing the system operations in the theatres;

FIG. 4 is a more detailed flow chart of theatre operations;

FIG. 5A is a flow chart detailing the operation of the lobby terminals;

FIG. 5B shows further detail of the tagging process of FIG. 5A;

FIG. 6 shows the features available from a remote terminal;

FIG. 7 is a flow chart detailing the game operation;

FIG. 8 is a flow chart showing the details of processing an advertisers order for product display in the system;

FIG. 9 details the process involved in receiving and filling product orders from consumers; and

FIG. 10 illustrates the process of preparing and issuing a smart card to a consumer.

### DETAILED DISCRIPTION OF THE PREFERRED EMBODIMENT

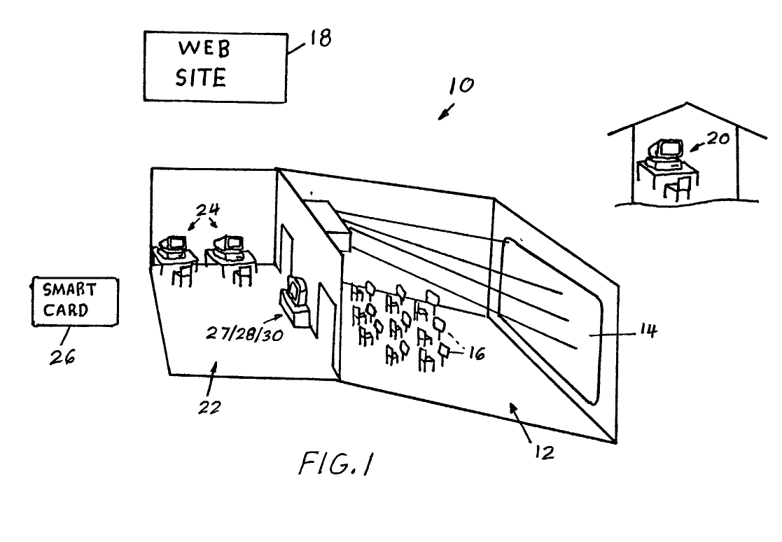

A preferred embodiment of the merchandizing system of the present invention is illustrated in FIG. 1. An electronic merchandizing center 10, preferably located in a large shopping area includes a theatre 12 having a large feature screen 14 for displaying an advertiser's product descriptions, product feature productions and other information related to the system. The merchandizing system includes a server 28 for maintaining a system web site 18 on which product advertisements and other features to be described are included and available to members of the merchandizing center. The theatre 12 includes theater terminals that are preferably individual touch screen displays 16 for participants in accessing the center web site 18 while in the theatre. Advertisers can purchase time and space on the large feature screen 14 and the center web site 18. Consumers may access the web site from any connected terminal, such as a home PC 20. The center also includes a lobby 22 with several lobby terminals 24 that preferably include touch screen displays, designed for ease of use and low maintenance. According to the preferred embodiment, a consumer obtains a membership in the center 10 and receives a smart card 26 and/or PIN number allowing access to the web site 18 through any terminal having access to the network. The content displayed on the large feature screen 14 is supplied from a local video server. The content on the theater terminals 16, the lobby terminals 24, and the remote terminals 20 is supplied by the center data server 28 that can be locally or remotely located, or rented space on a network server. In the event a consumer elects to purchase a product, the server 28 is programmed to send the order to a center purchasing file, whereupon the order is transmitted to the corresponding advertiser. The advertiser can be a retailer, wholesaler or manufacturer. Redeemable coupons, and games with prizes are offered as an incentive for members to access and use the system often.

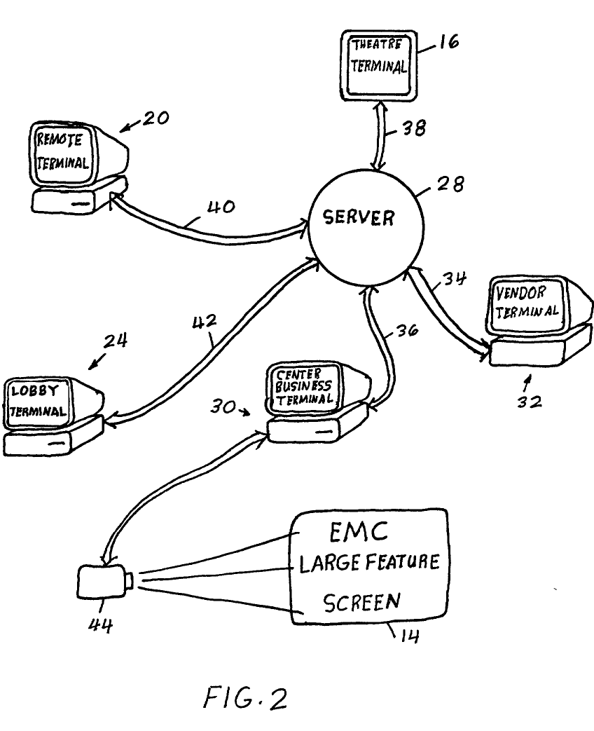

The physical structure is further illustrated in reference to FIG. 2, showing the various participants and the communication lines. A merchandising center business computer terminal 30 receives advertisements, product shows, etc. preferably from an advertiser's/vender's computer 32, by way of the center web site server 28 as indicated by lines 34 and 36. Members view product information at a lobby terminal 24, or at a theater terminal 16 while in the theatre 12, or through a remote terminal 20, such as a member's home computer. These connections are indicated in FIG. 2 by lines 38, 40, 42. A consumer can order products from a vender by accessing the web site 18 server 28 from any of the terminals, including a center 10 lobby terminal 24, theater terminal 16, or remote terminal 20. Orders are sent by the server 28 to the business terminal 30, or directly to center purchasing. Consumer identification and orders are sent by purchasing to the vendor 32 (line 34). Selected product shows and advertisements are sent to projector 44 for display on the large feature screen 14.

In summary of the above general description of the present invention, the purpose of the theatre is to display entertaining product shows, selected advertisements, and to introduce the consumer to the benefits of membership in the electronic merchandising center/system. Upon becoming a member of the merchandizing system, the consumer receives a smart card for the purpose of accessing a center web site. Access can be attained through a center terminal or other compatible network connected computer. Advertisers pay to have their products displayed in the theatre and advertised through the center web site. Consumer orders for products are made through the web site, and preferably transmitted through the computer network to the center computer 30. The center then receives payment from the consumer, places the order with the supplier, assures delivery, and pays the vendor.

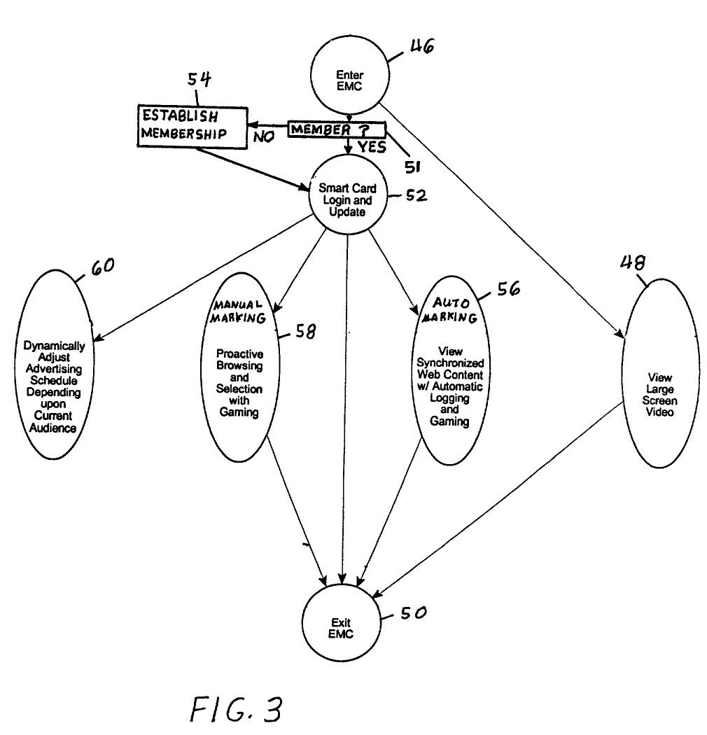

Referring now to FIG. 3, the process of becoming a member of the center is illustrated along with additional features of the invention. A customer typically enters 46 the center 10 and views a product show 48, etc. on the large feature screen 14. The customer can then simply exit 50, or if the customer is a member (51), can proceed to log onto the terminal 52 by using an issued smart card. If the consumer is not a member, a membership can be established 54. The member is issued a smart card or a PIN number to perform the login operation to access the web site. Once logged onto the center web site, the member can choose one of two alternative methods of viewing the web contents. A selection of synchronized viewing 56 causes the site to automatically display products in a time and sequential manner, and automatically marks or highlights the products that the consumer views in the theatre for the consumer's easy reference. The system also records on the consumer's smart card a credit called an E-Pon, i.e. an electronic coupon, or “coupon” towards the purchase of certain products, as a reward for logging onto the site and viewing advertisements. The member may also be rewarded with electronic play points for use in playing games on the web site, with the prospect of winning a prize, as well as earning more play points and coupons. Instead of choosing synchronized viewing, the consumer may choose to selectively/manually browse the web site for particular products 58, and to manually highlight selected products for future reference. As with the automatic alternative, the consumer also accumulates play points.

Block 60 indicates another novel feature of the center 10. The center computer 28 automatically keeps a record of products consumers select for viewing, and automatically adjusts the theatre shows to reflect the interests of consumer's in attendance in the theatre who have logged onto a theater terminal

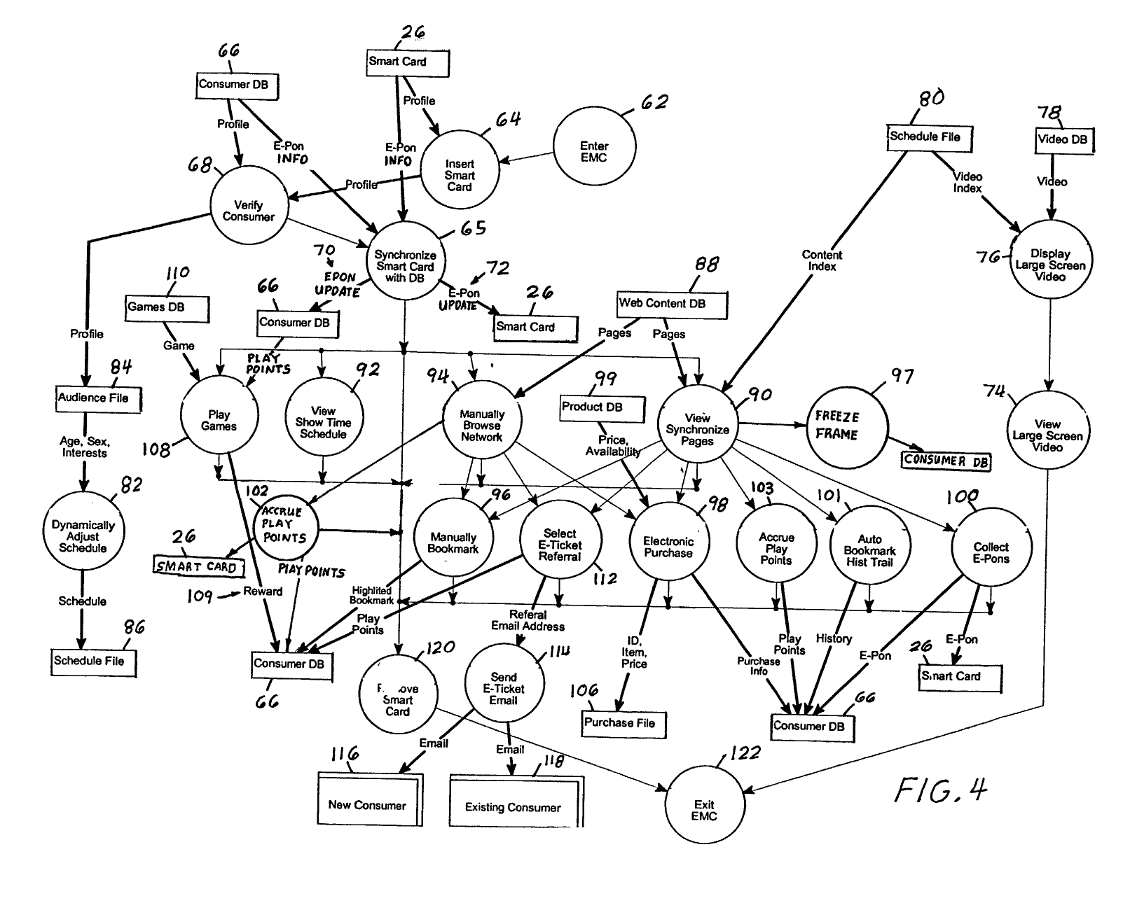

FIG. 4 displays various operations that occur when a member is in the theatre. The process begins with a member entering the center 62 and inserting 64 the issued smart card into a theater terminal. The terminal loads/reads the member's profile, including identification and interests from the card 26 and verifies 68 the profile with the corresponding data in the company computer/server database 66. The “E-Pon” lines in the figures indicate the electronic coupons, i.e. the coupons granted for logging onto the site and viewing advertisements. The number of coupons and play points indicated on the members smart card 26 is compared 65 with the data on the consumer database 66 in the server, and the server or smart card is updated appropriately. Coupons generally have an expiration date, and expired coupons are deleted 72 from the smart card 26 at this time.

A product show from a video database 78, adjusted according to a schedule file 80, is then displayed 76 on the large feature screen and viewed 74 by the member. The content displayed on the large screen is determined in part by the predetermined schedule 80, but is modifiable 82 upon evaluation of an audience file 84 including data from the consumer database 66 relating to the members who have logged onto the theater terminals. The audience file 84 is used to create an adjusted schedule 86 to replace schedule 80. The adjusted schedule 86 for the large screen is also used to adjust the selection and sequence i.e. content index of the synchronized pages 88 for the automatic, timed sequence display of products on the theater terminals 16 according to block 90.

A member in the theatre can view 92 the large screen “show time schedule” on the theater terminal 16, and can choose to either view the automatically displayed product sequence 90 or manually select 94 the products. For either manual or automatic viewing, the member can manually mark items for future reference 96, and orders can be placed 98 from a product database 99. In the case of synchronized viewing 90, the system will automatically mark items 101, creating a trail/history for the member. The member in the theater can also select a freeze frame 97 button on the theater terminal 16 touch panel to indicate a highlighted interest in the product or products currently being displayed on the large feature screen 14. The selected frame is then stored in the consumer database 66 for later review. Alternatively, the member can choose to manually mark selected items 96. The basic web content 88 supplied by the server is the same for either manual or automatic mode of operation in the theatre.

Rewards are given for using the system in the form of coupons (E-Pons) 100 for viewing advertisements, and in the form of play points 103, 102 for browsing the product pages. In each case, a record of coupons and play points is recorded on the smart card 26 and in the system/server consumer database 66. When a member places an order to purchase a product 98, the member identification, item, price, etc. are recorded in a server purchase file 106.

FIG. 4 also shows the games feature 108, supported by the games database 110 containing the game programs, and supported by the consumer database 66 for entry of earned and stored play points required in order to play the games. When a member plays the game and a prize is won (reward) 109, a record of this is entered into the consumer database 66. The reward can be a particular product or a prize, or more generally it will be a credit, called a “netstamp” towards the purchase of products included in an online “prize catalog”. In addition to the above described ways of earning play points, a member can earn play points by referring a product 112 by e-mail 114 to either a non-member 116 or a member 118. This is noted as an “E-ticket” in FIG. 4. In order to leave the theatre, the member removes the smart card 120 and exits 122.

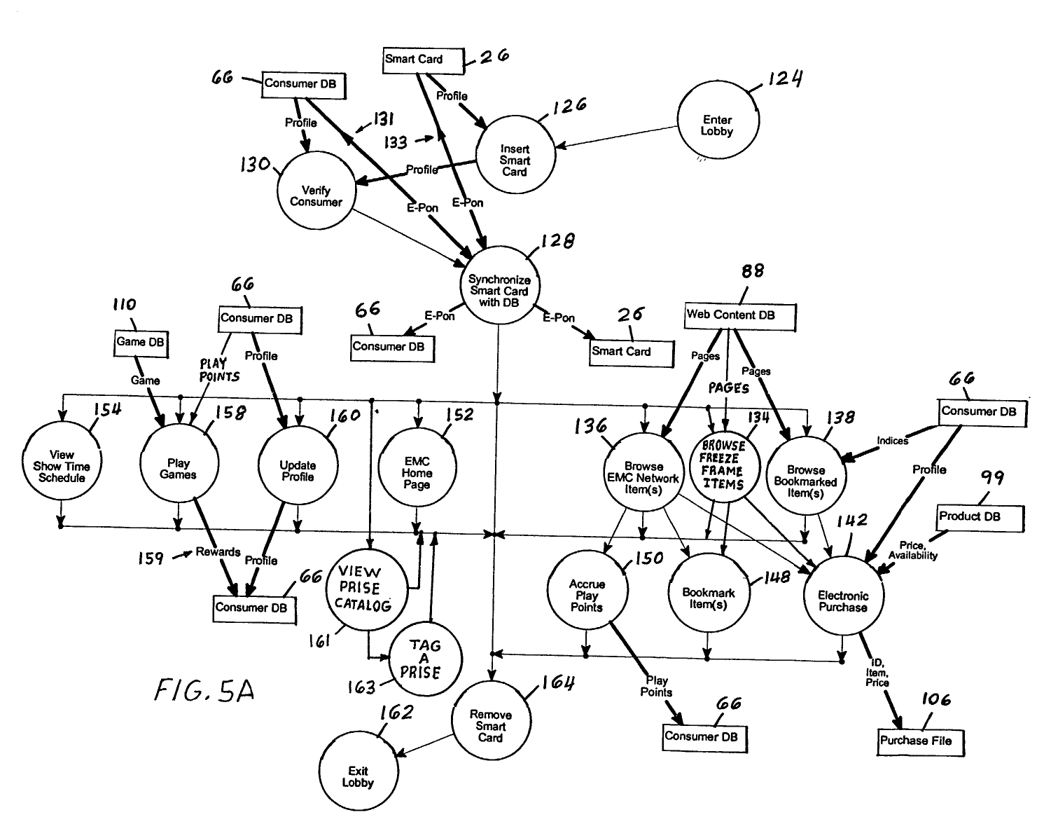

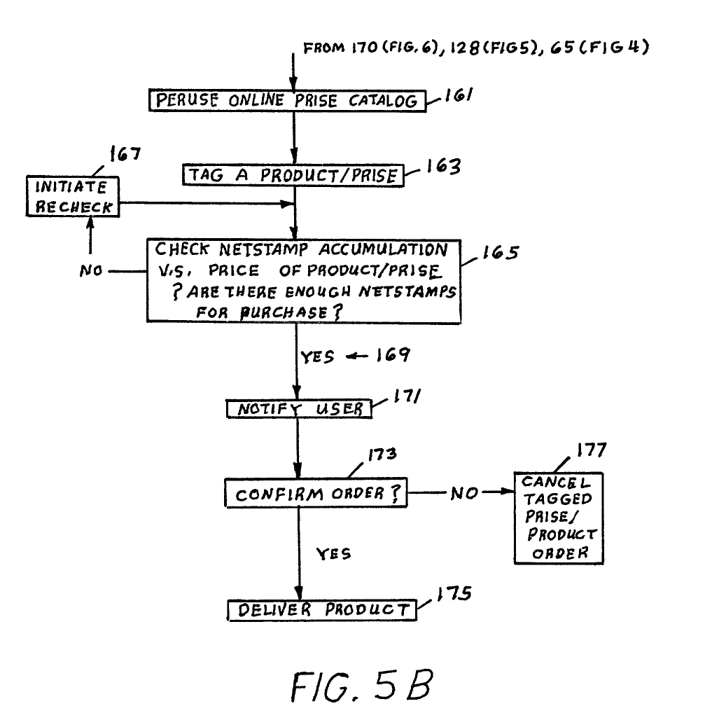

FIG. 5A illustrates the use of a lobby terminal 24. A member enters 124 the lobby 22 and inserts 126 a member smart card in the terminal 24. The data from the smart card 26 is compared 128 with the server consumer database 66 to verify 130 the customer and to update 131 the coupon (E-Pon) data in the consumer database 66 to match the data on the card 26. Synchronization 128 also causes expired coupons to be deleted 133 from the smart card 26. Once the member has successfully activated the terminal, the web site can be entered and product items from the web content database 88 can be browsed. Browsing can be limited to the marked items 130 or to the freeze frame highlighted items 134, or can be items in general 136. Orders for products 142 in the product database 99 can be made. The order is accompanied by the appropriate consumer data from the consumer database 66, and is placed in the purchase file 106. The member can mark items 148 for future reference, and in the process will accrue play points 150, which will be stored in the consumer database 66. The member can view 152 the center home page, and the show time schedule 154. Games in the game database 110 can be played 158 based upon required play points earned and stored in consumer database 66, and records of any rewards/prizes 159 are stored in the consumer database 66. These rewards can be points which will be referred to as netstamps with a value towards the purchase of a prize from a prize catalog. A member can also update 160 the member profile, the old data being retrieved from the consumer database 66 and corrected/updated data sent back. An additional feature of the present invention that can be applied to any of the terminals as described in reference to any of the figures, is illustrated in FIG. 5, wherein a member can view a game prize catalog 161 and tag a particular prize 163 that the member wants, and which can be delivered when sufficient netstamps are accumulated. This will be more fully described in reference to FIG. 5B. When the member desires to leave 162, the card is removed 164 from the workstation.

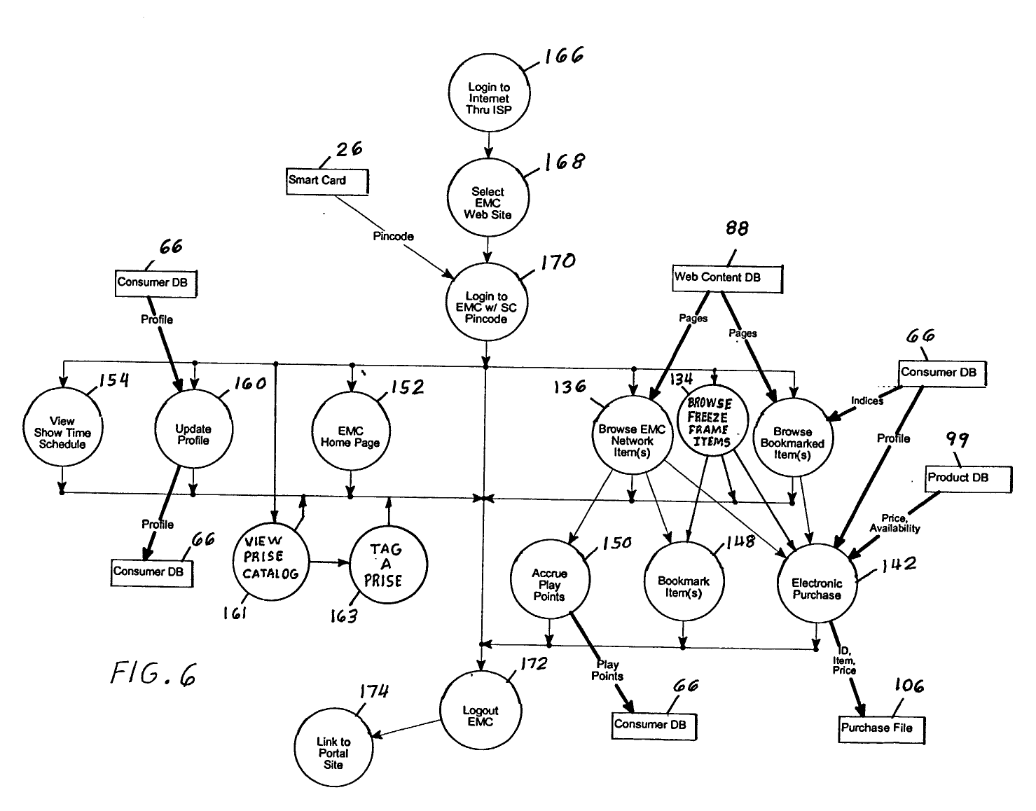

A process of selecting, tagging and delivery of prizes from the online prize catalog is also illustrated in FIG. 5A. This begins after a member logs into the web site, as indicated for example by completion of processes 65 of FIG. 4, 128 of FIG. 5, or 170 of FIG. 6. The member, once in the site, can peruse 161 the online prize catalog and tag 163 a desired product. The server is programmed to automatically check 165 for accumulated netstamps in the consumer database 66. If there are not enough netstamps to purchase the prize, the system waits for a set time interval or event and initiates 167 another check 165. This process continues until there are enough netstamps to purchase/redeem the tagged product/prize 169. At this point the member is notified that the tagged prize can be redeemed/purchased 171. The member then can either confirm or cancel the order 173. If the member confirms the order, the prize is delivered 175 and the corresponding netstamps are deleted from the consumer database 66. If the order is denied, the tagged item is cancelled 177 and the system no longer checks for netstamps in the database 66 to cover that item, and proceeds to check the database 66 for netstamps to cover a second tagged item, if there is one. Otherwise the system simply waits for another item to be tagged, which is simply a repeat of steps 165-173, etc. FIG. 6 illustrates a member's access to the web site from any remote terminal, such as a member's home computer. In this case, the member logs into the internet 166 and selects the center web site 168. Login is accomplished with keyboard entry of a PIN number 170. The remaining details of browsing, marking, purchasing, accessing the schedule, home page, and updating the profile, etc. are all identical to that described in reference to FIG. 5. In order to exit, the member logs out of the center 172 site and is linked to a web portal site 174. The remote terminal differs from the lobby terminal in that it does not provide access to the games. This is set forth as the preferred embodiment. An alternative embodiment includes the games at the remote site functioning as described in reference to FIG. 5.

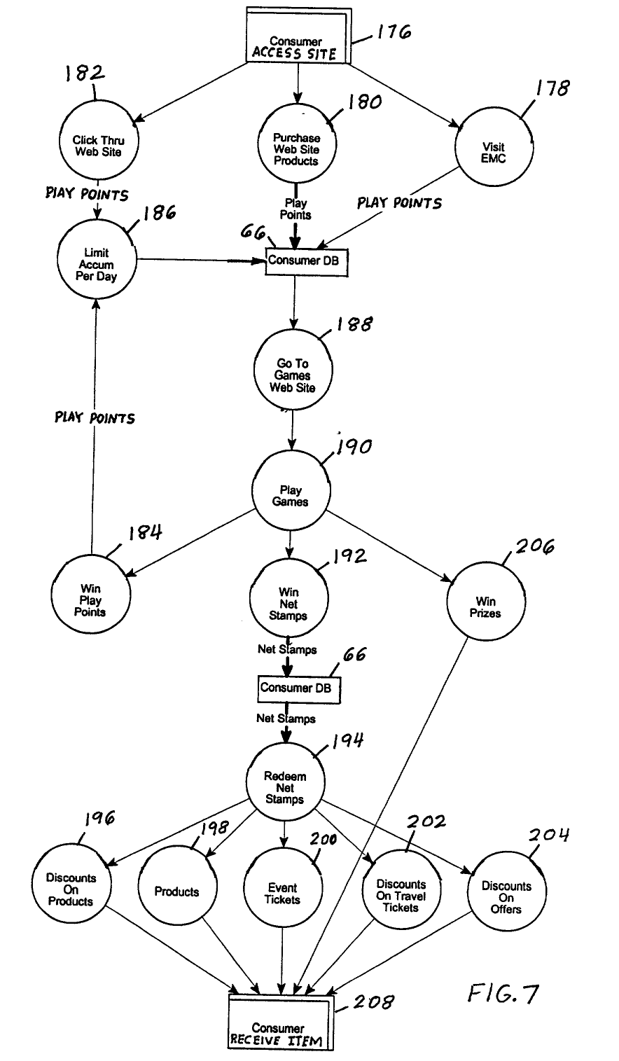

FIG. 7 illustrates the game system in further detail. In order to play the games, a member must first access 176 the web site and then accumulate “play points” in the consumer database 66. Play points can be accrued by visiting the center 178, purchasing web site products 180, clicking through the web site 182 and by playing games 184. The number of points that can be accumulated in one day by playing games is limited 186. A member with play points goes to the web site 188, and in the process of playing games 190, can win net stamps 192 which are recorded in the consumer database 66. Net stamps are similar to the coupons discussed above, and are redeemable 194 in a variety of ways, indicated in FIG. 7 as discounts on products 196, fill product purchase 198, purchase of event tickets 200, discounts on travel tickets 202 and on offers 204. Other ways of redeeming stamps or coupons are also included in the present invention. Some direct prizes from advertisers 206 can also be won by playing the games. These items are received by the consumer 208.

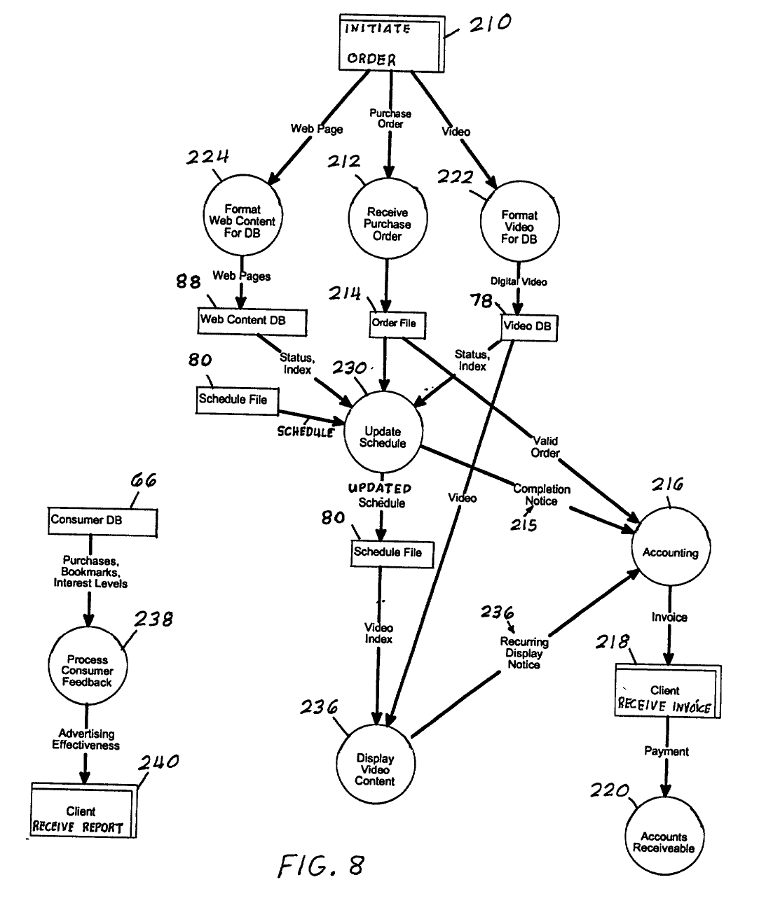

FIG. 8 illustrates the processes involved in the advertiser/client and merchandizing center relationship. An advertiser/client initiates an order 210. The merchandizing center receives 212 a purchase order from the advertiser/client for display of the advertiser's product. The order is placed in an order file 214 and a notice is sent to accounting 216. An invoice is sent and received 218 by the client and payment is received by accounts receivable 220. The center receives the required video format 222 and web content 224 from the client, and these are placed in a video database 78 and web content database 88 respectively. The large screen theatre schedule is updated 230 from a previous schedule 80 to an updated schedule 80 to reflect the new advertiser's purchase order, and notice of the update. A completion notice 215 is sent to accounting, along with an accounting of recurring displays 236 for invoicing and reporting 218 to the client.

As a client service, the center also prepares a report 238 from the consumer database 66, including purchases, bookmarks (marking) and interest levels of the members, and sends this to the client 240.

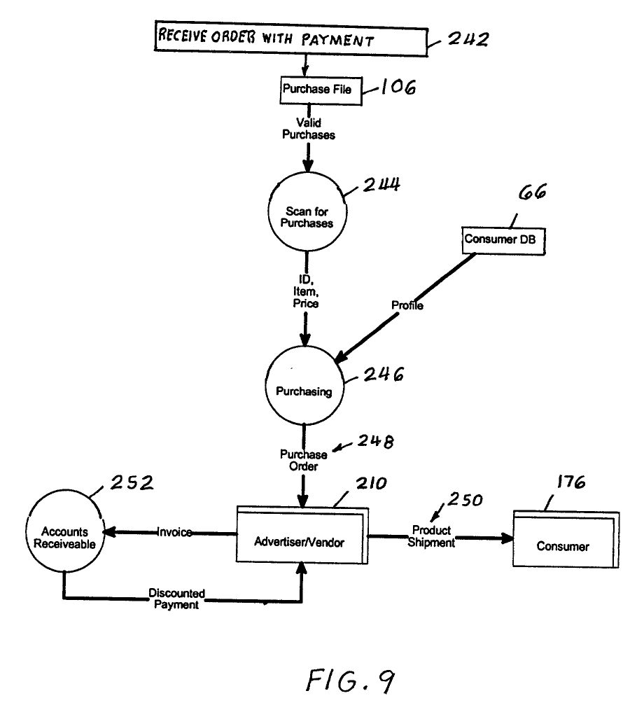

FIG. 9 shows the processes involved in handling a member's purchase order for an advertiser's product. A member places an order through use of the web site as described in reference to the previous figures. The order is received 242 by the center with payment. The order is placed in the purchase file 106. The server scans for valid orders 244 and submits the required data to purchasing 246. This data includes identification of the item and price, and the member/consumer identification from the consumer database 66. Purchasing 246 submits a purchase order 218 to the advertiser/vendor 210. The vendor ships 250 the product to the consumer 176, invoices accounts receivable 252 and payment is made to the vendor.

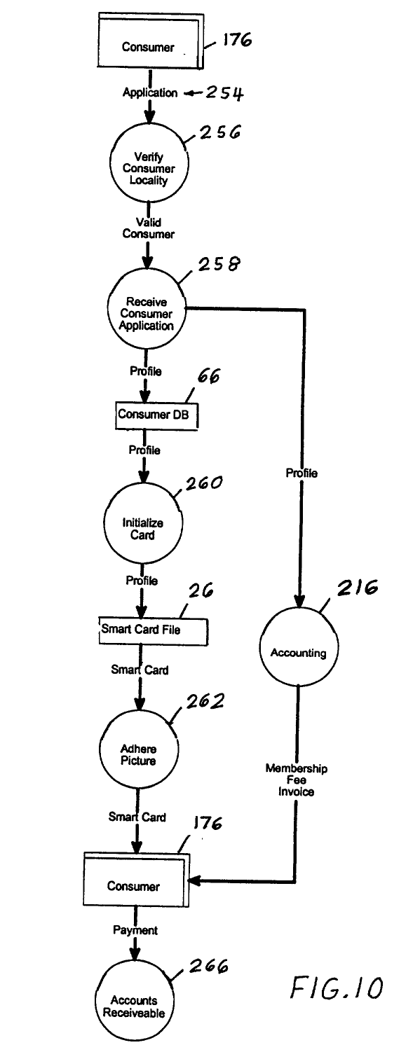

FIG. 10 illustrates the steps involved in preparing a member's smart card. A consumer 176 submits an application 254, and the data is verified 256 and received as a valid application 258. The consumer data is then entered into the consumer database 66. A smart card is initialized 260 and the consumer data is placed in the card 26. A picture of the consumer is placed on the card 262. The card, and an invoice from accounting 216 for the fee for preparing the card, is sent to the consumer 176. The consumer pays accounts receivable 266 and becomes a valid member.

Although the present invention has been described above in terms of a specific embodiment, it is anticipated that alterations and modifications thereof will no doubt become apparent to those skilled in the art. It is therefore intended that the following claims be interpreted as covering all such alterations and modifications as fall within the true spirit and scope of the invention.

What is claimed is:

1. A merchandising system comprising:
(a) a merchandising facility including a motion picture theatre having a large feature screen for display of a product feature production and a product advertisement; and
(b) an electronic merchandising network site provided by a communications network server, said site for use by a user for viewing site content including said product advertisements; and
(c) terminal apparatus including at least one terminal for use by a user of said merchandizing facility for access to said network site.

2. A system as recited in claim 1 wherein said terminal apparatus includes at least one theater terminal for individual use by a person while attending said motion picture theater.

3. A system as recited in claim 1 further comprising:
(a) a lobby in proximity to said theater; and
(b) wherein said terminal apparatus includes at least one individual terminal located in said lobby.

4. A system as recited in claim 1 wherein said site includes means allowing a user to order a product online.

5. A system as recited in claim 4 wherein said merchandizing system further includes
(a) a game means including
(i) a game accessible through said site and playable by a system user having a play point; and
(ii) issue means for issuing a play point to a system user.

6. A system as recited in claim 5 wherein said game means further includes a reward for playing said game.

7. A system as recited in claim 6 wherein said reward is a netstamp for use in procuring a product from an online catalog.

8. A system as recited in claim 6 wherein said reward is a prize.

9. A system as recited in claim 6 wherein said issue means includes
(a) means for issuing a play point for viewing the products displayed in said site; and
(b) means for issuing a play point for referring a product to another person.

10. A system as recited in claim 7 wherein said game means further includes
(a) tagging means wherein a user can tag a product for purchase; and
(b) means for checking a consumer database to determine if said user has a sufficient quantity of netstamps to procure said tagged product, and if said user has enough netstamps, the product is delivered to said user, and if said user does not have enough netstamps, said means for checking rechecks said consumer database at a later time.

11. A system as recited in claim 2 wherein said theater terminal includes means for freeze framing a product advertisement to be stored in a consumer database for future review through said site.

12. A system as recited in claim 1 further comprising coupon means for electronically issuing a coupon to a user for logging onto said site, said coupon for credit towards the purchase of a product.

13. A system as recited in claim 12 wherein said coupon is issued for reviewing advertisements on said site.

14. A system as recited in claim 12 wherein said coupon has an expiration date.

15. A system as recited in claim 1 wherein said site is accessible from a remote terminal.

16. A system as recited in claim 1 wherein said terminal includes a touch screen.

17. A system as recited in claim 1 wherein working access to a said terminal is limited to a user having a prescribed membership.

18. A system as recited in claim 17 wherein access to said terminal is further limited to a user having an issued smart card.

19. A system as recited in claim 5 further comprising:
(a) means for detecting a user's product selection entered on said theatre terminal and for detecting user data on said user's smart card; and
(b) means for selecting said product feature production and advertisement based on said selection and said user data.

20. A system as recited in claim 1 wherein said site content is automatically displayed sequentially.

21. A system as recited in claim 1 wherein said site content is selected manually .

22. A system as recited in claim 17 wherein user can record data on said user's smart card to highlight a selected product.

23. A system as recited in claim 12 wherein said server includes means for loading data representing said coupons onto a user's smart card; and wherein said coupon has an expiration date.

24. A system as recited in claim 23 wherein said server further includes
(a) means for storing a record of coupon redemptions in said server;
(b) means for updating server content; and
(c) means for deleting a coupon that is older than said expiration date from a smart card.

25. A system as recited in claim 1 further comprising means for displaying a schedule of product feature productions on a said terminal.

26. A system as recited in claim 1 further comprising:
(a) means for entry of a user's personal data in said server; and
(b) means for modification of said personal data.

27. A system as recited in claim 4 further comprising:
(a) means for receiving said order by said company;
(b) means for said company placing said order with a vendor of said products;
(c) means for receiving payment from said user; and
(d) means for payment to said vendor.

28. A system as recited in claim 1 further comprising:
(a) a smart card;
(b) means for entering a user's personal data on said smart card, said smart card for use by said user in obtaining access to said site; and
(c) means for a user obtaining a membership in said center including means for receiving a user application for said membership, said application including personal data.

29. A system as recited in claim 12 further comprising:
(a) means for recording a record of said coupon in the form of coupon data on said card; and
(b) means for updating said coupon data on said card.

30. A system as recited in claim 9 wherein said means for issuing further includes means for granting a play point for purchasing a product advertised on said site.

31. A system as recited in claim 30 wherein said play points that can be accumulated by a user in one day are limited to a pre-determined quantity.
